(19) United States
(12) Patent Application Publication
(10) Pub. No.: US 2002/0149553 A1
(43) Pub. Date: Oct. 17, 2002

(54) Display device having driving elements, and driving method thereof

(76) Inventors: Takatoshi Tsujimura, Fujisawa-shi (JP); Kohichi Miwa, Kanagawa-ken (JP); Hiroshi Suzuki, Yamato-shi (JP)

Correspondence Address: IBM CORPORATION, T.J. WATSON RESEARCH CENTER, P.O. BOX 218, YORKTOWN HEIGHTS, NY, 10598, US

(21) Appl. No.: 09/825,240

(22) Filed: Apr. 3, 2001

(51) Int. Cl. G09G 3/36

(52) U.S. Cl. 345/92

(57) ABSTRACT

A liquid crystal display device includes plural pixels by using a dot reversal driving system. The pixel includes a display electrode to apply voltages to a liquid crystal display material, a first switching element brought into connection with the display electrode and undergoing ON/OFF switching with scanning signals to be applied to a gate line of the first switching element, and a second switching element brought into connection with the display electrode and undergoing ON/OFF switching which is interlocked to ON/OFF switching of an adjacent pixel among the plural pixels.

### FIELD OF THE INVENTION

The present invention relates to technology to improve displaying quality in a display device, particularly in a liquid crystal display device.

### BACKGROUND OF THE INVENTION

Higher resolution in a display, which used to be slow in progress in CRT displays, is about to make rapid progress by introducing new technology such as new liquid crystal and so on. That is, a liquid crystal display device can relatively easily achieve high resolution by subjecting micro-processing, compared with CRT displays.

As one of liquid crystal display device, a liquid crystal display device of active matrix system using a Thin Film Transistor (TFT) is known. The liquid crystal display device of this active matrix system comprises a TFT array substrate in which gate lines and signal lines being disposed like a matrix with TFTs being disposed at intersection points thereof, an opposite substrate disposed at a predetermined distance with that substrate, and liquid crystal member, wherein the liquid crystal member is sealed into the space between the TFT array substrate and the opposite substrate, and voltages being applied to this liquid crystal member are controlled by the TFT so as to give rise to electro-optical effect of liquid crystal to enable display.

As structure of a TFT, structures of top gate type (forward stagger form) and bottom gate type (reverse stagger type) are conventionally known. With reference to FIG. 9, structure of a TFT of top gate type is described in such a way that a TFT of top gate type comprises a shield film 102 on an insulation substrate 101 such as glass substrate and the like, and thereon an insulation film 103 made of silicon oxide (SiOx) and Silicon nitride (SiNx), etc. is provided. Thereon, a drain electrode 104 and a source electrode 105 made of ITO (indium-tin oxide) film, which are spaced with the channel interval, are provided, and laminated by an amorphous silicon film (a-Si film) 106 as a semiconductor layer covering both of those electrodes, and thereon a gate insulation film 107 and gate electrode 108 made of SiOx and SiNx, etc. so that an island-like region called a-Si island is formed.

Since the life of liquid crystal is shortened when a direct voltage is applied, alternate voltages are applied thereto for operation. In that case, polarity of voltages applied to the liquid crystal member is inverted in every frame, that is, in every period from starting of one display on one screen to completion thereof, but such a method that inverts the whole screen simply and at the same time will give rise to crosstalk and therefore is not practical. Accordingly, in order to avoid the crosstalk, a driving method in which phases for polarity reverse on each pixel undergo divergence is adopted. Typically, known are H-line reversal driving system in which the phases are inverted on every one horizontal line, V-line reversal driving system in which the phases are inverted in every one vertical line, and dot reversal driving system (or HN-line reversal driving system) in which the phases are inverted in every one pixel alternately.

In order to apply a sufficient voltage to each pixel of a liquid crystal display device, a TFT is required to have sufficient driving ability. In particular, when a liquid crystal display device becomes enlargement and high definition, the delay in gate lines is enlarged and hence the time for charging is shortened, and then the driving ability required to a TFT becomes larger. Write charging ability of the TFT is proportionate to its sizes, more specifically, to the channel interval, and therefore, in order to attain sufficient displaying quality, it is necessary to form a large-sized TFT compared with the size of the pixels. Enlargement of the TFT, that will give rise to decrease in numerical aperture, will not be a desired solution.

To solve the shortage in writing voltage by the TFT, Published Unexamined Japanese Patent Application No. 63-287829 specification discloses a driving method to supply plural pulses, as the selection signals, to gate lines within one frame period. More specifically, the pulses to be supplied to gate lines within one frame period consist of twos, G and G′. The pulses G and G′, whose pulse width is as short as less than one horizontal scanning time, can not cause a pixel voltage to come close to the displaying signal with one pulse, but that arrangement is Claimed to be attainable by the pulse G′ being supplied first so that the pixel voltage is increased to reach a predetermined value and by the pulse G being supplied thereafter so that the pixel voltage reaches the displaying signal. In the 63-287829 prior art, the timings of the pulses G and G′ are diverged by three times compared with the horizontal scanning time. This is caused because a liquid crystal display device, which comprises a color filter of three colors (R, G, and B), that make use of the fact that one same color closely correlated with the display signal would come in every period multiplied by three on the horizontal scanning time, so that the writing efficiency of the display signal voltage onto the pixel voltage is caused to increase further.

The technology disclosed in Published Unexamined Japanese Patent Application No. 63-287829 specification is a driving system, which can be called a precharge system, and is disclosed in Published Unexamined Japanese Patent Application Nos. 2-168229 specification, 4-180014 specification, and 5-100636 specification.

In addition, in Published Unexamined Japanese Patent Application No. 11-101967 specification, in order to implement sufficient writing, or providing a charge for the pixels, a liquid crystal display device that comprises two TFTs, which are disposed for one pixel, require each to have a signal line drive circuit.

However, Published Unexamined Japanese Patent Application No. 63-287829 specification and others do not suggest any application to a dot reversal driving system which is advantageous for crosstalk prevention. Moreover, as described in detail in the embodiments hereinafter, in the case where writing characteristics are severe, that is, writing time is short, the charging error may occur. In the method of Published Unexamined Japanese Patent Application No. 63-287829 specification in which the timings of the pulses G and G′ are diverged by three times compared with the horizontal scanning time, it has been confirmed that gray scale error, such as gray scale shift, caused by the charging error is visually conceivable.

In addition, the liquid crystal display device disclosed in Published Unexamined Japanese Patent Application No. 11-101967 specification requires two signal lines to be formed for one pixel, that will become a cause to give rise to decrease in numerical aperture of the liquid crystal display panel. Accordingly, there are disadvantages in terms of enlargement and high definition for the liquid crystal display device.

### SUMMARY OF THE INVENTION

Accordingly, an object of the present invention is to provide a display device that can solve the charging error in writing into pixels. In addition, another object of the present invention is to provide a liquid crystal display device that can solve the charging error in writing onto pixels in a liquid crystal display device of the dot reversal driving system and a method for driving thereof. Moreover, another object of the present invention is to provide a display device in that gray scale error caused by charging error, which causes in the case of severe writing characteristics is not conceivable visually.

A feature of the present invention includes a display device comprising a display electrode to apply a driving voltage to an optical element for displaying, a first switching element to control the driving voltage onto the display electrode, a second switching element to control the driving voltage onto the display electrode, a first gate line to transmit scanning signals to the first switching element, a second gate line to transmit scanning signals to the second switching element, a scanning signal supply section supplying scanning signals to the first gate line and the second gate line, a first signal line for transmitting displaying signals to the first switching element, a second signal line for transmitting displaying signals to the second switching element, and a displaying signal supply section supplying displaying signals to the first signal line and the second signal line through the identical circuit.

Another feature of the present invention includes a liquid crystal display device having plural pixels by using a dot reversal driving system, wherein the pixel comprises a display electrode to apply voltages to a liquid crystal display material, a first switching element brought into connection with the display electrode and undergoing ON/OFF switching with scanning signals to be applied to a gate line of the first switching element, and a second switching element brought into connection with the display electrode and undergoing ON/OFF switching which is interlocked to ON/OFF switching of an adjacent pixel among the plural pixels.

Still another feature of the present invention provides a liquid crystal display device having a display section in which pixels are arranged as a matrix, comprising a display electrode, a first pixel comprising a first and a second TFTs as switching elements for the display electrode, and a second pixel brought into connection with a gate line which is connected with the second TFT of the first pixel, wherein the second TFT of the first pixel is operated by scanning signals supplied by the second pixel, and the display signals supplied to the second pixel are also supplied to the display electrode of the first pixel via the second TFT.

Yet another feature of the present invention is to provide a liquid crystal display device of dot reversal driving system, comprising a first pixel having a display electrode to supply a voltage onto a liquid crystal material, a first signal line to supply the first pixel with a first display signal, a second pixel which is adjacent to the first pixel and to which a voltage in the same polarity is applied, a second signal line to supply the second pixel with a second display signal, and a supply route to supply the second display signal to the display electrode of the first pixel.

According to yet another feature of the present invention, a driving method of a LCD, which can be realized, on the liquid crystal display device of dot reversal driving system in which gate lines and signal lines are arranged as a matrix, in the event of applying a driving voltage to the first pixel, comprises a first step of applying a voltage to a first pixel, wherein the voltage is based on the voltage driving a second pixel adjacent to the first pixel and having the same polarity with the first pixel, and subsequently a second step of applying a driving voltage to the first pixel itself.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE DRAWINGS

FIG. 1 is a schematic view showing a main configuration of a liquid crystal display device related to the embodiment according to the present invention hereof.

FIG. 2 is a circuit diagram equivalent to an array substrate A of the liquid crystal display device related to the embodiment.

FIG. 3 is a partially enlarged view of FIG. 2.

FIG. 4 is a schematic plan view showing a portion of the array substrate A.

FIG. 5 is a graph showing a driving waveform of the liquid crystal display device related to the embodiment.

FIG. 6 is a graph showing a driving waveform of a conventional liquid crystal display device.

FIG. 7 is a drawing to describe a dot reversal driving system adopted by the embodiment.

FIG. 8 is an explanatory view to describe a structure of a TFT of bottom gate type.

FIG. 9 is an explanatory view to describe a structure of a TFT of top gate type.

FIG. 10 is a circuit diagram equivalent to pixels of a conventional liquid crystal display device.

FIG. 11 is a drawing showing a gray scale error according to the embodiment.

FIG. 12 is a drawing showing a gray scale error according to the conventional device.

FIG. 13 is an explanatory view to describe different in the case where the ON timing of a main charge subsequent to a pre-charge is caused to be changed.

### DETAILED DESCRIPTION OF THE INVENTION

In order to solve said problems, the display device which has switching elements, specifically two TFT in one pixel was considered. One of the TFT is intended to be used for pre-charge while the other one is intended to be used for charging subsequent to the pre-charge (hereinafter, it is called “main charge”).

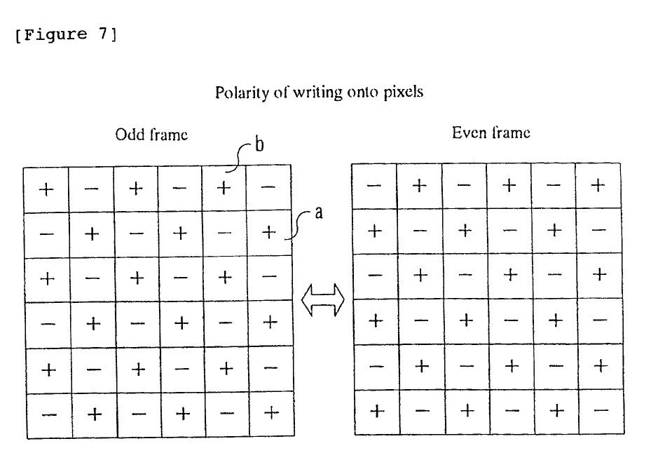

Here, in the dot reversal driving system, as described above, writing polarities to pixels are inverted the phase in every one pixel alternately (see FIG. 7). With respect to a particular pixel (herein a pixel a), prior to implementation of the main charge, a driving voltage at the time when an adjacent pixel (in FIG. 7, a pixel, that is “pixel b,” located obliquely upper from the particular pixel) having the same polarity in said frame undergo main charging, can be used for a pre-charge of the pixel a. Accordingly, the TFT to implement pre-charge of the pixel a is brought into connection with the gate line and the signal line of said pixel b, which will serve to cause the TFT for pre-charge of the pixel a to undergo ON switching at the same time when the TFT for the main charge of the pixel b, that is, in an interlocking fashion, so that the pixel a will undergo pre-charge.

According to the display device of the present invention, the first switching element is brought into connection with the first gate line and the first signal line, and the second switching element is brought into connection with the second gate line and the second signal line. Accordingly, the first switching element undergoes ON/OFF switching with scanning signals supplied to the first gate line so that voltages are applied onto the display electrode. On the other hand, the second switching element undergoes ON/OFF switching with scanning signals supplied to the second gate line so that voltages are applied onto the display electrode. That is, the second switching element can implement pre-charge and the first switching element can implement main charge. This means that the first switching element and the second switching element have different timings of voltage application onto the display electrode. In addition, the first switching element and the second switching element apply voltages in the same phase onto the display electrode so that pre-charge can undergo efficiently.

Here, there is a case where another switching element is brought into connection with the second gate line and the second signal line. Then, when the second gate line is supplied with scanning signals, the switching element and the second switching element undergo ON/OFF switching. Another pixel includes another switching element that is disposed to the adjacent to the pixel in which the first switching element and the second switching element are provided. When this is compared with the liquid crystal display device of dot reversal driving system, the two pixels can have the relationship between the pixel a and the pixel b shown in FIG. 7.

In addition, according to the present invention, provided is a display device comprising a single scanning signal supply section and a single display signal supply section with gate lines extending from the single scanning signal supply section and signal lines extending from the display signal supply section being arranged as a matrix so as to form pixels, wherein the pixel comprises a first switching element brought into connection with the n-th gate line described above and the m-th signal line described above, a second switching element brought into connection with the (n−1)-th gate line and the (m−1)-th signal line, and a display electrode controlled by the first and second switching elements. And, by means of this display device, the second switching element can implement pre-charge.

According to the present invention, provided is a liquid crystal display panel or cell having gate lines supplying scanning signals and signal lines supplying display signals being arranged as a matrix comprising an intersecting section in which the gate lines and the signal lines intersect, and two TFTs brought into connection with the same signal line around the intersecting section. The liquid crystal display panel uses two different TFTs as different pixels, but each TFT is brought into connection with the same gate line. Hence, the two different TFT can be interlocked to be driven when scanning signals are applied to the gate line, and the liquid crystal panel can be caused to undergo ON/OFF switching. In the liquid crystal display panel, such an intersecting section, or two TFTs are disposed as a matrix, and therefore, in the two TFTs, one TFT can be used for pre-charge, and the other TFT can be used for additional charge subsequent to the pre-charge.

According to this liquid crystal display device, when the switching element of the adjacent pixel undergoes ON switching, the second switching element also undergoes ON switching. In addition, since the second switching element and the switching element of the adjacent pixel are brought into connection with the same signal line, the voltage essentially to be applied onto the adjacent pixel is also applied onto the pixel via the second switching element. This voltage is used as pre-charge, and subsequently a main charge can be implemented via the first switching element. That is, after a voltage is applied onto the display electrode via the second switching element, another voltage can be written onto the display electrode via the first switching element.

In this LCD device, the display signal supplied to the second pixel is also supplied to the display electrode of the first pixel via the second TFT, and this display signal can perform its role as a pre-charge.

This liquid crystal display device comprises a first signal line supplying the first pixel with display signals and a second signal line supplying the second pixel with display signals so that it can be structured with the first TFT being brought into connection with the first signal line and the second TFT being brought into connection with the second signal line. That is, the two TFTs existing in the same pixel are respectively brought into connection with different signal lines.

According to this liquid crystal display device, via the supply route, to the first display electrode, the second display signal can be supplied and thereafter the first display signal can be supplied with the first signal line. In addition, the second display signal supplying makes pre-charge, and the first display signal supplying makes additional charge or main charge. Incidentally, with the supply route being structured to be able to be opened and closed, the second display signal can be supplied to the display electrode timely.

In this liquid crystal display device, the voltage applied in the first step can be based on a scanning signal applied to the gate line being different from that in the second step. In addition, the voltage applied in the first step can be based on a display signal applied by the signal line different from that in the second step.

A display device of the present invention will be described as below based on practical embodiments on a liquid crystal display device.

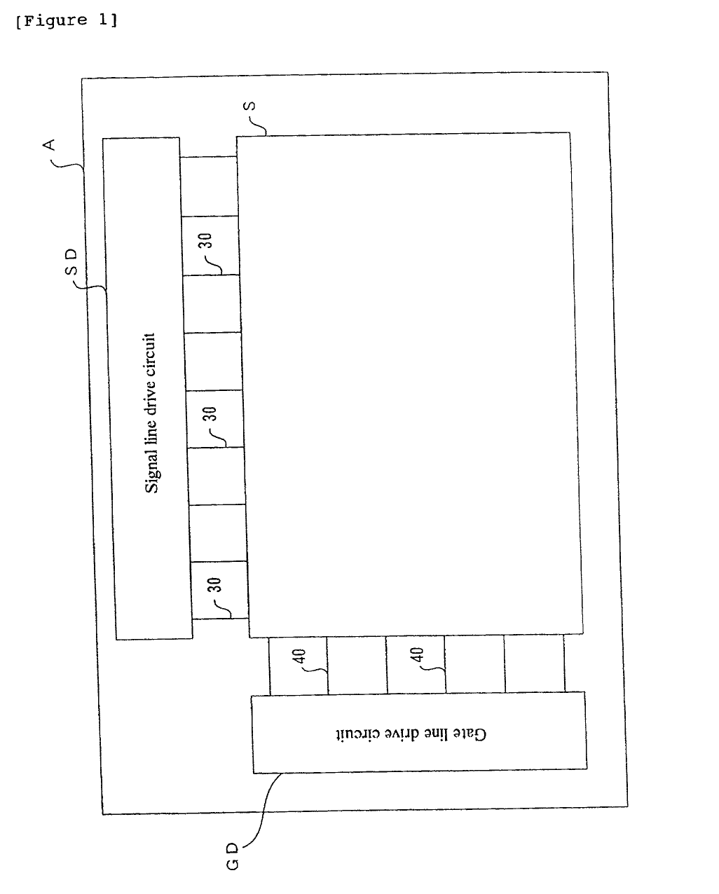

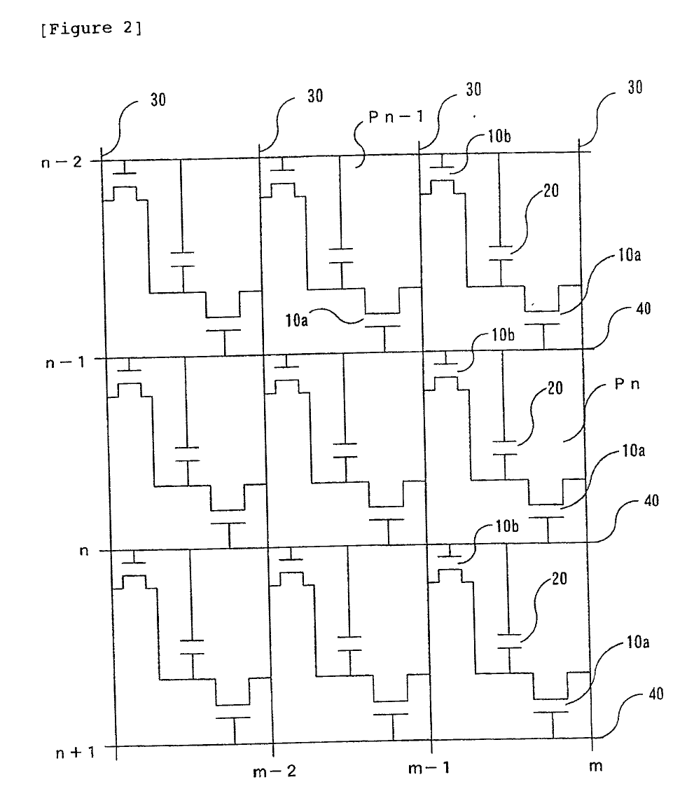

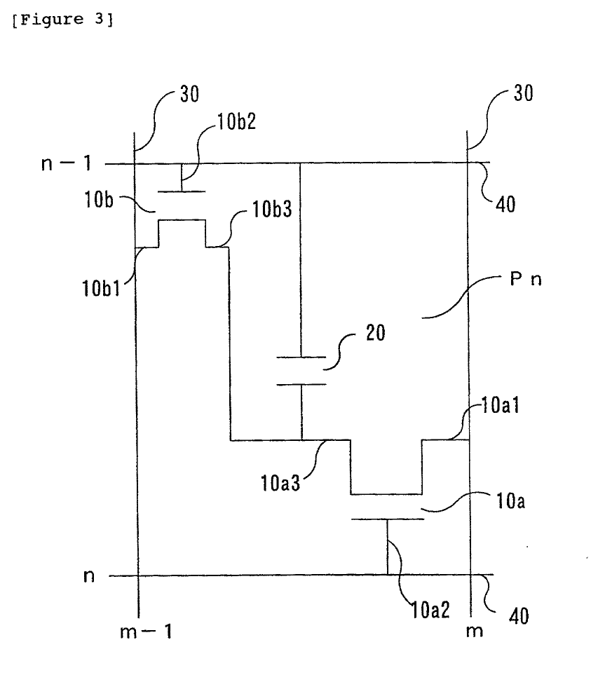

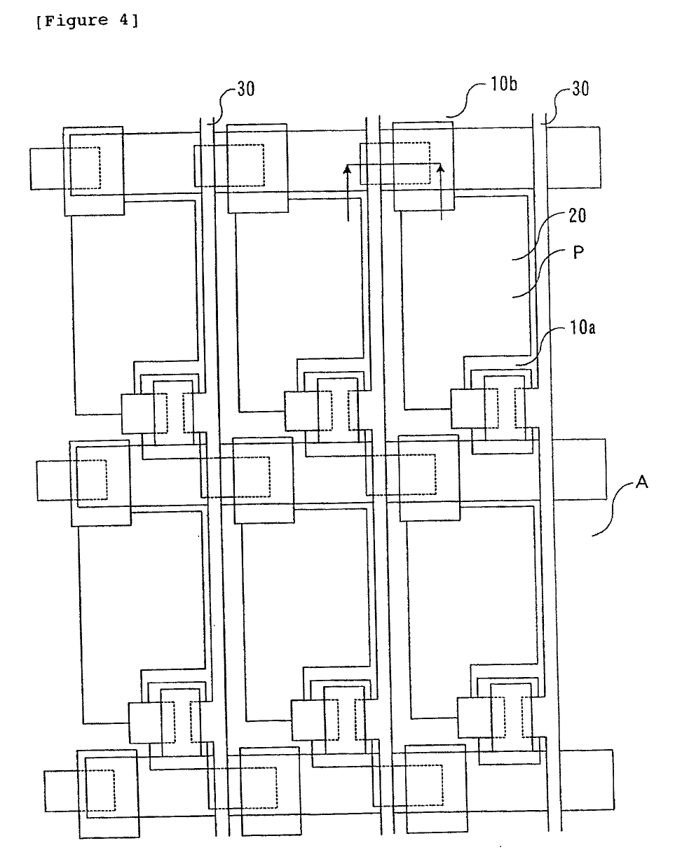

FIG. 1 is a schematic view showing a basic structure of an array substrate A of a liquid crystal display device related to an embodiment hereof, FIG. 2 is an equivalent circuit diagram of pixels being disposed as an matrix inside the active region S, FIG. 3 is a partially enlarged view of FIG. 2, and FIG. 4 is a plan schematic view of one portion of the array substrate A.

A liquid crystal display device related to this embodiment has a liquid crystal panel as its characteristic element, in which a liquid crystal material used as an optical element for display is held between an array substrate A and an opposite substrate (not shown), the array substrate A having a display electrode 20 and TFTs 10a and 10b used as two switching elements brought into connection with the display electrode 20, which are disposed as a matrix on the array substrate A, and the opposite substrate having common electrodes disposed thereon. Of course, as a liquid crystal display device, other elements such as backlight unit, etc. are necessary, but they are not characteristic elements of the present invention, and therefore detailed description thereof will be omitted hereafter.

The liquid crystal display related to the present embodiment is a device adopting a dot reversal driving control system. The dot reversal driving control system is as described above one in which phases are inverted every one pixel alternately. This is illustrated in FIG. 7. In FIG. 7, each boxes in which the signs “+” or “−” are assigned represents each single pixels. And, as shown in FIG. 7, the writing polarity applied onto a pixel shows a pixel with “+” polarity in an odd frame shows “−” polarity in an even frame, and on the other way around, a pixel with “−” polarity in an odd frame shows “+” polarity in an even frame. Furthermore, in any frame, writing voltages for pixels adjacent each other in the diagonal direction will be obvious to be in the same phase. This is alternately repeated on the odd frames and the even frames. Accordingly, the present embodiment comprises a not shown polarity inversion circuit as well. Incidentally, the frame being referred to herein refers to a period from the beginning of scanning subsequently from the top to the bottom of all the gate lines 40 to completion of one display on one screen.

As shown in FIG. 1 thru 4, the array substrate A comprises a signal line drive circuit SD to supply displaying signals, that is, to apply voltages, to display electrodes 20 via the signal lines 30 and a gate line driving circuit GD to supply scanning signals to control ON/OFF of TFTs 10a and 10b via the gate lines 40. The signal line driving circuit SD of the present embodiment makes a display signal supplying section consisting of a single circuit. And, the gate line driving circuit GD makes scanning signal supplying section consisting of a single circuit as well.

As shown in FIG. 2 thru FIG. 4, the signal lines 30 and the gate lines 40 are disposed as an matrix so that a region enclosed by the signal line 30 and the gate line 40 forms a single pixel.

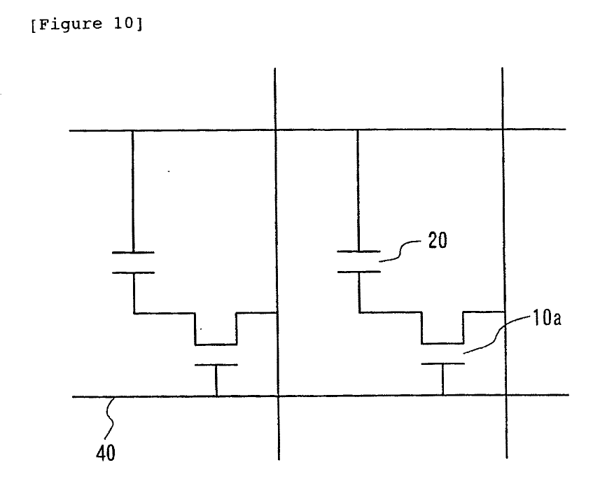

Configuration of a single pixel will be described based on a pixel Pn located in the most right middle in FIG. 2. A single pixel Pn comprises a display electrode 20 and two TFTs 10a and 10b being brought into connection herewith. FIG. 10 shows an equivalent circuit diagram showing pixels in a conventional liquid crystal display device using TFTs, but the conventional liquid crystal display device complies only one TFT 10a. That is, the liquid crystal display device according to the practical embodiment can be the to have a configuration in which a TFT 10b is added to a conventional liquid crystal display device.

In FIG. 3, the TFT 10a comprises a drain electrode 10a1 brought into connection with a signal line 30, a gate electrode 10a2 brought into connection with a gate line 40, and a source electrode 10a3 brought into connection with a display electrode 20. In addition, the TFT 10b comprises a drain electrode 10b1 brought into connection with a signal line 30, a gate electrode 10b2 brought into connection with a gate line 40, and a source electrode 10b3 brought into connection with a display electrode 20.

In general, for the array substrate A, insulating materials such as non-alkaline glass and quartz, etc. are used. In addition, the display electrode 20 is made by a transparent conductive film such as indium-tin oxide (ITO) and the like, and the signal line 30 and the gate line 40 are made by a conductive film of pure Mo, and an alloy thereof, such as Mo—W alloy, etc. Without being limited to those indicated herein, these materials configuring the array substrate A may take place into other materials.

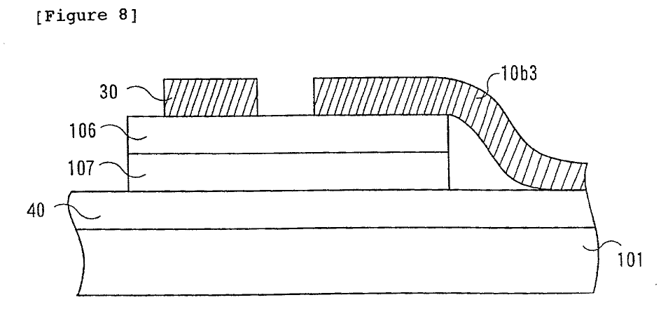

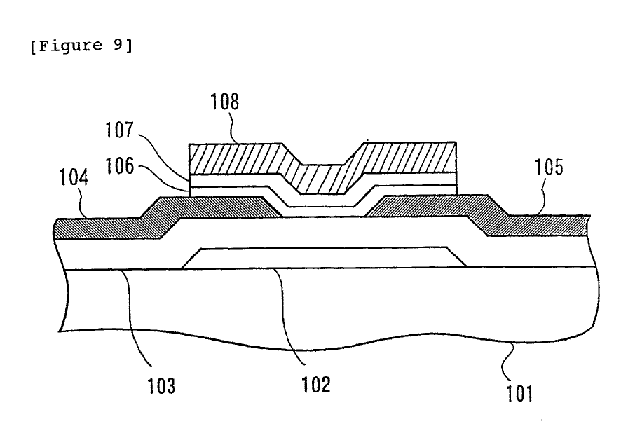

As the TFTs 10a and 10b used in this embodiment, a conventional known configuration may well be adopted. In the present embodiment, TFTs of the top gate type (or the stagger type) as the TFT 10a, and of the bottom gate type (or the reverse stagger type) as the TFT 10b are adopted. Configuration of TFT of the top gate type is as already described based on FIG. 9. Accordingly, here a sectional structure of the TFT 10b will be described briefly based on FIG. 8. As shown in FIG. 8, the TFT 10b is configured by a gate line 40 formed on an insulation substrate 101, a gate insulation film 107 formed on the gate line 40, a-Si film 106 as a semiconductor layer formed on the gate insulation film 107, and a signal line 30 and a source electrode 10b3 formed on the a-Si film 106. Here, the gate line 40 functions as the gate electrode 10b2, and the signal line 30 functions as the drain electrode 10b1.

In FIG. 2 and FIG. 3, ON/OFF switching of the TFTs 10a and 10b of the pixel Pn is controlled by scanning signals being supplied from the gate line drive circuit GD to the gate line 40. Driving control in each of the TFTs 10a and 10b is as follows. At first, the TFT 10b which is supplied with scanning signal by the gate line driving circuit GD via the gate line 40 denoted by reference numeral n−1 in the drawing is brought into the ON state. Then, a display signal supplied to the signal line 30 denoted by reference numeral m−1 in FIG. 2 is selected so that a voltage is applied to, that is, written onto the display electrode 20 of the pixel Pn. Next, the TFT 10a which is supplied with scanning signal by the gate line driving circuit GD via the gate line 40 denoted by reference numeral n in the drawing is brought into the ON state. Then, a display signal supplied to the signal line 30 denoted by reference numeral m in the drawing is selected so that a voltage is applied to, that is, written onto the display electrode 20 of the pixel Pn. After all, onto the display electrode 20 of the pixel Pn, a voltage is firstly written by the TFT 10b and subsequently written by the TFT 10a.

The scanning signal to the TFT 10b of the pixel Pn is not to be supplied only for the purpose of switching the TFT 10b to ON. But also, the scanning signal supplied via the gate line 40 denoted by the reference numeral n−1 in the drawing is also supplied to the TFT 10a of the pixel Pn−1 so that, with this scanning signal, the TFT 10a of the pixel Pn−1 is turned to ON switching. Accordingly, the TFT 10b of the pixel Pn can be turned to ON or OFF switching with being interlocked with the TFT 10a of the pixel Pn−1 by means of the scanning signal to the TFT 10a of the pixel Pn−1. Here, in the present invention, as for the pixel Pn−1, the gate line 40 denoted by the reference numeral n−1 will be referred to “a gate line of its own,” and the signal line 30 denoted by the reference numeral m−1 will be referred to “a signal line of its own.” As well as, for the pixel Pn, the gate line 40 denoted by the reference numeral n will be referred to “a gate line of its own,” and the signal line 30 denoted by the reference numeral m will be referred to “a signal line of its own.”

As described above, the liquid crystal display device according to the embodiment follows the dot reversal driving system. Accordingly, the pixel Pn and the pixel Pn−1 have the charging polarity of the same phase. In other words, the TFT 10b of the pixel Pn can be referred to a TFT, which undergoes ON-OFF switching, control coinciding with the TFT 10a of the adjacent pixel Pn−1 having the charging polarity of the same phase. Moreover, as a note, the pixel Pn undergoes pre-charge so as to receive a writing voltage in advance from the adjacent pixel Pn−1 having a charging polarity of the same phase. And thereafter, based on the scanning signal to be supplied to the gate line 40 denoted by the reference numeral n being a gate line of its own, the TFT 10a will undergo ON switching to implement application of the writing voltage. The applications of the voltage by the TFT 10b to the pixel Pn and to the pixel Pn−1 are implemented pixel Pn−1 within a same frame period.

Here, description has been made with reference to relationship between the pixel Pn and the pixel Pn−1, but similar pre-charge of writing voltage is executed between other pixels being adjacent to each other and having the same charging polarity of the same phase.

The TFT 10b of the pixel Pn and the TFT 10a of the pixel Pn−1 are disposed in positions which are in periphery of the portion intersected by the gate line 40 denoted by the reference numeral n−1 and the signal line 30 denoted by the reference numeral m−1, more specifically, are symmetrical with respect to the intersection portion as the point of symmetry. In addition, the TFT 10b and the TFT 10a belong to the pixel Pn and the pixel Pn−1 which are respectively different, but are brought into connection with the same gate 40 denoted by the reference numeral n−1 and with the same signal line 30 denoted by the reference numeral m−1. Due to such a configuration being adopted, the TFT 10b of the pixel Pn undergoes coinciding ON/OFF switching control with the TFT 10a of the adjacent pixel Pn−1 having the writing polarity of the same phase. In addition, the TFT 10b of the pixel Pn functions as a supply route to supply to not only the display electrode 20 of the pixel Pn−1 but also the display electrode 20 of the pixel Pn the displaying signal to be supplied to the signal line 30 denoted by the reference numeral m−1.

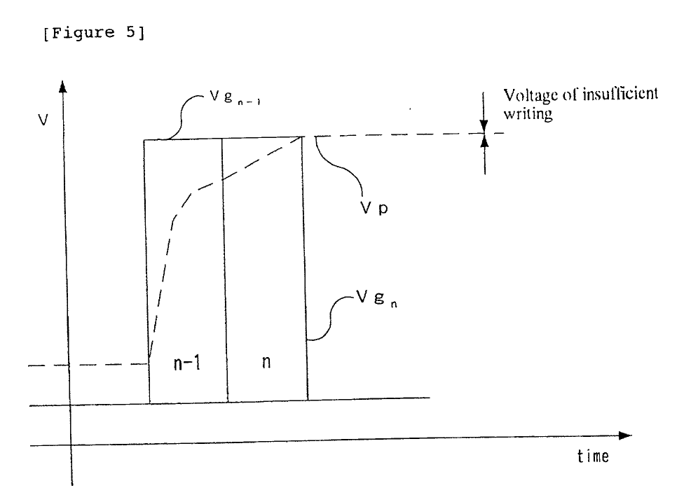

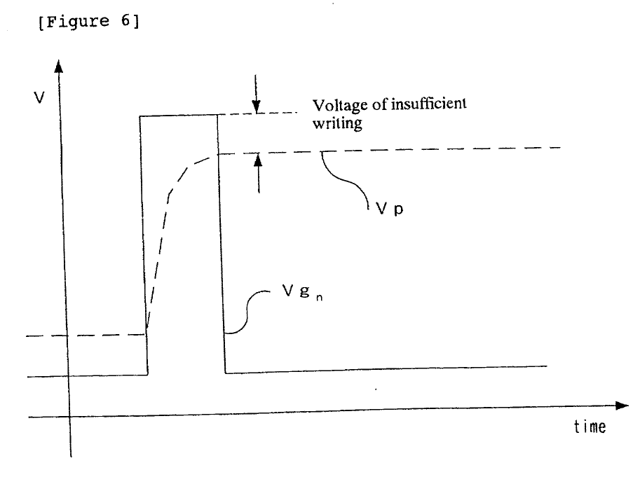

FIG. 5 is a graph showing a driving waveform of a liquid crystal display device related to the embodiment, and FIG. 6 is a graph showing a driving waveform of a conventional liquid crystal display device. Here, a conventional liquid crystal display device has a configuration in which no TFT 10b exists in the embodiment as shown in FIG. 10, and accordingly only the writing voltage from the TFT 10a functions.

At first, FIG. 6 will be described with reference to FIG. 10. FIG. 6 is a timing chart showing voltages (Vg) applied to the TFT 10a via the gate lines 40 and the writing voltages (Vp) in the display electrode 20. In case of the conventional liquid crystal display device, voltages (Vp) of the display electrode 20 do not reach an ideal voltage (shown by a dashed line in the drawing). This takes place since the onset of the writing voltage of the display electrode 20 is delayed from the writing time (the width of the pulse Vg).

On the other hand, in case of the present embodiment shown in FIG. 5, the pixel Pn (in FIG. 3) is described as an example as follows. The scanning signal on gate line 40, denoted by the reference numeral n−1, serves to apply the pulse voltage Vgn−1 to the TFT 10b of the pixel Pn. Then the TFT 10b of the pixel Pn brings the TFT 10b of the pixel Pn into an ON state so that the displaying signal of the signal line 30 denoted by the reference numeral m−1 is supplied to the display electrode 20 of the pixel Pn via the TFT 10b. Accordingly, the writing voltages of the display electrode 20 are set on as shown in FIG. 5. This is pre-charge. However, the state of writing insufficiency is still under way. Subsequently the scanning signal is supplied to the gate line 40 denoted by the reference numeral n, and the gate voltage Vgn is applied to the TFT 10a so as to enter the ON state. Then the display signal of the signal line 30 denoted by the reference numeral m is supplied to the display electrode 20 of the pixel Pn via the TFT 10a so that the writing voltage can reach an ideal voltage.

The present invention, which implement pre-charge as described above, can improve writing voltages into pixels. However, in the case where the writing time is extremely short or in the case where the voltage of pre-charge is low, it cannot be deniable that charging error takes place as well. This charging error is as same as in the pre-charge described in the Published Unexamined Patent Application No. 63-287829 specification. This charging error causes the gray scale error. However, there is an advantage that the pre-charge according to the present embodiment makes the range of the gray scale error less, that is, visually less unconceivable, than in the conventional technologies. This will be described as follows.

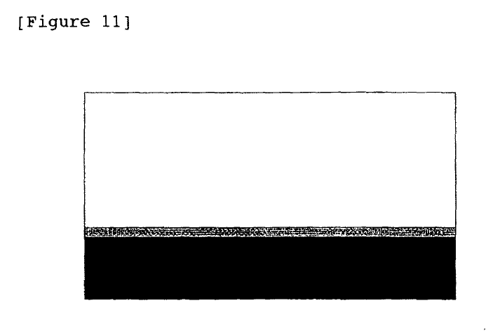

The boundary portion where the display color changes from white to black will be considered. In the embodiment, in terms of position of the gate line 40, the one to undergo pre-charge for the n-th gate line 40 is the (n−1)-th gate line 40. That is, in terms of the number of the gate line 40, the first preceding gate line will undergo pre-charge. Here, with the (n−1)-th line being white for the displaying color and with n-th line and after being black for the displaying color, and if charging error has taken place, the n-th line will become gray. This is due to the display color of the (n−1)-th line being while giving rise to insufficient onset of the writing voltage even if pre-charge is implemented. The n-th line is the one to undergo pre-charge for the (n+1)-th line, and the essential displaying color for the n-th line is black. Accordingly, the onset due to pre-charge for the (n+1)-th line is larger than the onset due to pre-charge for the n-th line. That is, the effect of pre-charge is large. Accordingly, the (n+1)-th line can display black color. This means that the charging error is worth only one line, that is, the n-th line. This is illustrated as shown in FIG. 11.

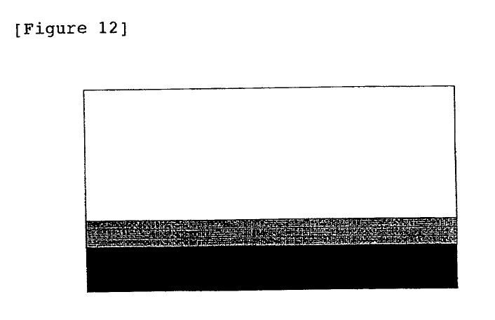

In the Published Unexamined Patent Application No. 63-287829 specification, as described above, the pre-charge and the essential charge undergo divergence by three times of horizontal scanning time. That is, the (n−3)-th line is the one to undergo pre-charge for the n-th line. Here, as described above, the displaying color for the (n−1)-th line and preceding lines is supposed to be white, and the displaying color for the n-th line and thereafter is supposed to be black. Then, since the (n−3)-th line whose displaying color is white is the one to undergo precharge for the n-th line, the n-th line displays gray color. Next, since the (n−2)-th line whose displaying color is also white is the one to undergo pre-charge for the (n+1)-th line, the (n−1)-th line will also be gray. The (n+2)-th line is likewise. Since the n-th line whose display color is black is the one to undergo pre-charge, the (n+3)-th line can display black color. This means that gray scale error is worth three lines, that is, n-th line, (n+1)-th line, and (n+2)-th line. This is illustrated as shown in FIG. 12.

As can be seen when FIG. 11 and FIG. 12 are compared, even if the gray scale error or the gray scale shift takes place, the present embodiment can provide images, which are less visually conceivable.

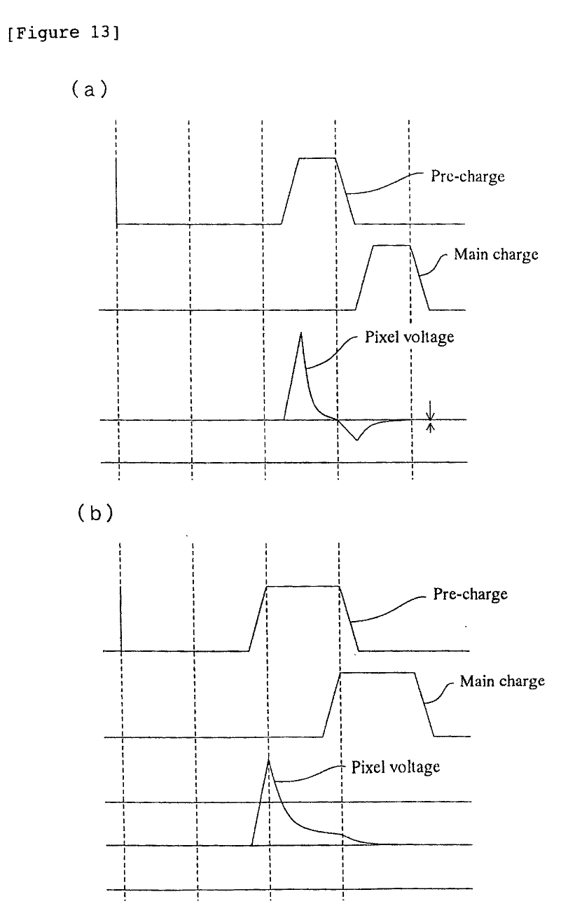

FIG. 13 is a drawing to describe the difference being given rise to when the timing of a main charge subsequent to the pre-charge, that is, the ON timing is varied in the embodiment. FIG. 13(a) shows the case where the ON timings for the pre-charge and the main charge do not overlap while FIG. 13(b) shows the case where the ON timings for the pre-charge and the main charge overlap.

In FIG. 13(a), the pixel voltage is set on by the pre-charge, but the voltage drops due to coupling with supplementary capacitance. This voltage drops, as shown in FIG. 13(a), to less than the voltage level being a goal. Accordingly, the main charge starts at a disadvantageous position in order to achieve the intended purpose. That is, function of pre-charge cannot be sufficiently realized. On the other hand, as shown in FIG. 13(b), in the case where the ON timings for the pre-charge and the main charge overlap, the main charge starts prior to the voltage drop by way of coupling with the supplementary capacitance. Since the voltage of the pixel at the beginning of this main charge is close to the target voltage, the function of the pre-charge can be realized sufficiently.

Overlapping of the ON timing between the pre-charge and the main charge means from another point of view that the writing time can be lengthened. Accordingly, in the present invention, it is preferred that the pre-charge and the main charge shall be controlled so that their ON timings overlap for the purpose of the longer writing time substantially in addition to bringing out effects of pre-charge sufficiently.

As described so far, according to the present embodiment, charging error is controlled and gray scale error can be controlled to a minimum even if the charging error takes place. Moreover, the writing time can be lengthened substantially.

Further, the present invention is not limited to the practical embodiment, but can undergo various changes within a range of the gist of the present invention.

As described so far, according to the present invention, a display device that can control a charging error onto a pixel is provided. In addition, according to the present invention, provided is a display device that can control a charging error onto a pixel and a driving method thereof in a liquid crystal display device of a dot reversal driving system. Moreover, according to the present invention, provided is a display device in that gray scale error due to the charging error taking place in case of strict writing characteristics is visually unconceivable.

It is to be understood that the provided illustrative examples are by no means exhaustive of the many possible uses for our invention.

From the foregoing description, one skilled in the art can easily ascertain the essential characteristics of this invention and, without departing from the spirit and scope thereof, can make various changes and modifications of the invention to adapt it to various uses and conditions.

It is to be understood that the present invention is not limited to the sole embodiment described above, but encompasses any and all embodiments within the scope of the following claims.

1. A display device, comprising:
a display electrode for applying a driving voltage to an optical element for displaying;
a first switching element which controls the driving voltage onto said display electrode;
a second switching element which controls the driving voltage onto said display electrode;
a first gate line which transmits scanning signals to said first switching element;
a second gate line which transmits scanning signals to said second switching element;
a scanning signal supply section which supplies said scanning signals to said first gate line and the second gate line;
a first signal line which transmits displaying signals to said first switching element;
a second signal line which transmits displaying signals to said second switching element; and
a displaying signal supply section which supplies said displaying signals to said first signal line and said second signal line through the identical circuit.

2. The display device according to the claim 1, wherein within an identical frame period, said second switching element implements voltage applying onto said display electrode, and subsequently, said first switching element implements additional voltage applying onto said display electrode.

3. The display device according to the claim 2, wherein said first switching element and said second switching element apply the voltages in the same phase onto said display electrode.

4. A liquid crystal display panel having gate lines supplying scanning signals and signal lines supplying display signals being arranged as a matrix, comprising:
an intersecting section in which said gate lines and said signal lines intersect; and
two Thin Film Transistors brought into connection with the same signal line in the periphery of said intersecting section.

5. The liquid crystal display panel according to the claim 4, wherein said two Thin Film Transistors respectively belong to different pixels.

6. The liquid crystal display panel according to the claim 4, wherein said two Thin Film Transistors are brought into connection with the same gate line.

7. A liquid crystal display device by means of dot reversal driving system having pixels, wherein an each of said pixels comprises:
a display electrode to apply voltages to a liquid crystal material;
a first switching element brought into connection with said display electrode and undergoing ON/OFF switching with scanning signals to be supplied to a gate line of said first switching element;
a second switching element brought into connection with said display electrode and undergoing ON/OFF switching which is interlocked to ON/OFF switching of an adjacent pixel among said pixels.

8. The liquid crystal display device according to the claim 7, wherein said second switching element and the switching element of said adjacent pixel are brought into connection with the same signal line.

9. The liquid crystal display device according to the claim 7, wherein after a voltage is applied onto said display electrode via said second switching element, a voltage is applied onto said display electrode via said first switching element.

10. A liquid crystal display device having a display section in which plural pixels are arranged as a matrix, comprising:
a first pixel comprising a display electrode, and a first and a second Thin Film Transistors as switching elements for said display electrode; and
a second pixel brought into connection with the same gate line as the gate line connected with said second Thin Film Transistor of said first pixel, wherein
said second Thin Film Transistor of said first pixel is operated by scanning signals supplied by said second pixel; and
the displaying signals supplied to said second pixel are also supplied to said display electrode of said first pixel via said second Thin Film Transistor.

11. The liquid crystal display device according to the claim 10, further comprising a first signal line supplying said first pixel with displaying signals and a second signal line supplying said second pixel with displaying signals,
wherein said first Thin Film Transistor is brought into connection with said first signal line and said second Thin Film Transistor being brought into connection with said second signal line.

12. A liquid crystal display device of dot reversal driving system, comprising:
a first pixel comprising a display electrode to supply a voltage onto a liquid crystal material;
a first signal line to supply said first pixel with a first displaying signal;
a second pixel which is adjacent to said first pixel and to which a voltage in the same polarity is applied;
a second signal line to supply said second pixel with a second displaying signal; and
a supply route to supply said second displaying signal to said display electrode of said first pixel.

13. The liquid crystal display device according to the claim 12, wherein said supply route can be opened and closed.

14. A driving method of a liquid crystal display device of dot reversal driving system in which gate lines and signal lines are arranged as a matrix, in the event of applying a driving voltage to a first pixel, comprising:
a first step of applying a voltage to a first pixel, wherein said voltage is based on the voltage driving a second pixel adjacent to said first pixel and having the same polarity with said first pixel; and
a second step of applying a driving voltage to said first pixel itself.

15. The driving method of a liquid crystal display device according to the claim 14, wherein said first step is based on a scanning signal supplied to the gate line different from the gate line in said second step.

16. The driving method of a liquid crystal display device according to the claim 14, wherein said first step is based on a displaying signal supplied by the signal line different from the signal line in said second step.

17. A display device comprising a scanning signal supply section and a single display signal supply section with gate lines extending from said scanning signal supply section and signal lines extending from said displaying signal supply section being arranged as a matrix so as to form pixels, wherein said pixel comprises:
a first switching element brought into connection with n-th said gate line and m-th said signal line;
a second switching element brought into connection with (n−1)-th said gate line and (m−1)-th said signal line; and
a display electrode controlled by said first and second switching elements.
